(19) United States
(12) Patent Application Publication
(10) Pub. No.: US 2024/0016696 A1
(43) Pub. Date: Jan. 18, 2024

(54) MASSAGE DEVICE WITH A VARIABLE SHAPE, METHOD FOR PRODUCING SAME, AND METHOD FOR DEFORMING A MASSAGE DEVICE WITH A VARIABLE SHAPE

(71) Applicant: EIS GmbH, Bielefeld (DE)

(72) Inventors: Alex Dumler, Bielefeld (DE); Alexander Anderton, Bielefeld (DE)

(73) Assignee: EIS GmbH, Bielefeld (DE)

(21) Appl. No.: 18/256,850

(22) PCT Filed: Dec. 13, 2021
(86) PCT No.: PCT/EP2021/085410

§ 371 Date: Jun. 9, 2023

(30) Foreign Application Priority Data
Dec. 11, 2020 (DE) 102020133207.6

(51) Int. Cl. A61H 23/02; A61H 19/00

(52) U.S. Cl. CPC A61H 23/0254; A61H 19/44; A61H 2201/1246; A61H 2201/5056; A61H 2201/0153; A61H 2201/5005; A61H 2201/0103

(57) ABSTRACT

The invention relates to a massage device with a variable shape for simulating the body and to a method for same, comprising a shaft-shaped core, a casing, within which the shaft-shaped core is at least partly arranged, and a chamber which is formed between the shaft-shaped core and the casing. According to the invention, the chamber is equipped with a plurality of filling bodies which provide the casing with a variable shape according to the arrangement of the filling bodies relative to one another and relative to the shaft-shaped core and the casing.

The invention relates to a massage device with a variable shape comprising a shaft-shaped core, a jacket within which the shaft-shaped core is arranged at least in sections, and a chamber formed between the shaft-shaped core and the jacket. Furthermore, the invention relates to a method for producing a massage device with a variable shape for physical stimulation. Furthermore, the invention relates to a method for deforming a massage device with a variable shape for physical stimulation.

A device of the type mentioned at the outset having such a chamber is known. In this device, a chamber volume of the chamber can be set variably between a first and a second chamber volume. For this purpose, air is supplied to or discharged from the chamber. If air is supplied to the chamber, a jacket is inflated like a balloon, so that a rotationally symmetrical contour is formed. If air is guided out of the chamber, the jacket receives a contour which essentially corresponds to the contour of a core.

CH 329 193 describes a massage device having an airtight hollow body, the wall of which partially bulges out as a result of pressure pulses for massage purposes.

A disadvantage of such a device is that a user cannot individually adjust the length and shape. Furthermore, an air-filled or inflated jacket yields more strongly in comparison to a device produced from a solid body. Furthermore, a valve has to be arranged in such solutions to prevent the vibrator from venting unintentionally during use. This increases the complexity of the vibrator and results in higher costs, both in production and if repairs become necessary. Finally, a valve is not completely leak-tight, so air will inadvertently escape over time, preventing a device from maintaining the preferred balloon-like shape for use.

Furthermore, DE 20 2017 001 116 U1 describes a dildo without a shaft, which has an airtight outer jacket that is filled with granules. Sufficient hardness for sexual stimulation is achieved by negative pressure inside the dildo. Even with such a solution that works using a negative pressure, there is the problem that the negative pressure is lost over time during use and thus the shape and rigidity of the dildo are also.

A massage device is also known, the length, circumference, and shape of which a user can vary. This massage device comprises a solid body consisting of a temperature-sensitive solid thermopolyester material, which is encased in a silicone jacket. The massage device is warmed up in hot water for a comparatively long period of time; then its length, circumference, and shape can be varied individually. In order for the deformed massage device to retain its shape—at least for a certain period of use—it is then to be cooled in cold water for some time.

However, this massage device has significant disadvantages. The massage device is only available for use after some preparation time. Furthermore, over the time of use, the massage device loses the shape, length, and circumference intended by the user.

It is therefore an object of the present invention to provide a massage device, a method for producing a massage device, and a method for using a massage device, which reduces or eliminates disadvantages of existing solutions. It is also an object of the present invention to provide a massage device, a method for producing a massage device, and a method for using a massage device, which can be varied in length, circumference, and/or shape at short notice and does not lose a set desired length, circumference, and/or shape over time.

The object of the present invention is achieved according to the massage device with a variable shape for physical stimulation according to claim 1.

The massage device comprises a shaft-shaped core, a jacket within which the shaft-shaped core is arranged at least in sections, and a chamber formed between the shaft-shaped core and the jacket. A plurality of filling bodies is contained in the chamber. The filling bodies give the jacket a variable shape depending on their arrangement relative to one another and relative to the shaft-shaped core and relative to the jacket.

The shaft-shaped core can be rod-shaped. The shaft-shaped core can include cylindrical and/or concave and/or convex sections. The shaft-shaped core is preferably a solid body. A solid body in particular does not have a cavity. The shaft-shaped core can also be designed as a hollow body. Such a hollow body comprises a cavity that is accessible via an opening. The cavity extends starting from the opening into an interior of the core to an end section of the core. Moreover, an inner side of a core wall delimits the cavity. The core wall has a wall thickness that can vary.

The shaft-shaped core designed as a hollow body can be designed, for example, to accommodate a vibration means, in particular a vibration motor, in the cavity. In particular, the inside of the core wall can be designed to accommodate the vibration means in a friction-locked manner and/or in a formfitting manner and/or in a materially-bonded manner. In particular, the inside of the core wall can extend in an arch, in particular convexly, for a friction-locked and/or formfitting connection, so that the cavity has a tapering cross section. Furthermore, the inside of the core wall can include a projection, in particular an annular projection, for a friction-locked and/or formfitting connection, which extends starting from the inside of the core wall into the cavity. The inside of the core wall can preferably also include a groove, in particular an annular groove, for a friction-locked and/or formfitting connection, which extends starting from the inside of the core wall in the direction of an outside of the core wall.

The jacket is preferably designed like a balloon. In particular, the jacket defines a cavity that is accessible via an opening in the jacket. The shaft-shaped core is arranged at least in sections inside the jacket. It can be preferred for the shaft-shaped core to be arranged entirely in the cavity inside the jacket.

The jacket thickness is in particular less than the wall thickness of the core wall of a shaft-shaped core designed as a hollow body. The jacket thickness can vary depending on the arrangement of the plurality of filling bodies relative to one another and relative to the shaft-shaped core and relative to the jacket.

A filling body of the plurality of filling bodies is, for example, spherical or free-form. In particular, one filling body of the plurality of filling bodies is bead-shaped or chip-shaped. Furthermore, it can be preferred that one filling body of the plurality of filling bodies is designed having three legs.

The individual filling bodies of the plurality of filling bodies are preferably designed to be identical. It can also be preferred that the plurality of filling bodies comprise filling bodies that designed to be different. For example, the plurality of filling bodies can comprise filling bodies which are in particular spherical and/or chip-shaped and/or free-form and/or three-legged.

A filling body of the plurality of individual filling bodies has in particular an extension of at least 0.5 mm, 1 mm, 1.5 mm, 2 mm, 2.5 mm or 3 mm and/or at most 0.5 mm, 1 mm, 1.5 mm, 2 mm, 2.5 mm, 3 mm, 3.5 mm, 4 mm, 4.5 mm, or 5 mm. The filling bodies of the plurality of individual filling bodies preferably have the same extension. It can be preferred that the filling bodies of the plurality of individual filling bodies have different embodiments of the extension. The filling bodies of the plurality of individual filling bodies are preferably designed to be identical.

The shaft-shaped core and/or the jacket are preferably connected to a housing. The housing is designed in particular as a handle section.

Such a massage device has the advantage that the length, circumference, and/or shape of the massage device can be varied as desired in the short term using the plurality of filling bodies arranged in the chamber between the jacket and the shaft-shaped core. Furthermore, the plurality of filling bodies has the advantage that the set length, circumference, and/or shape is not lost over time due to leakage or reversible material behavior.

According to a preferred embodiment of the massage device, the chamber has a chamber volume which has a first chamber volume in a first state and a second chamber volume in a second state, wherein the chamber volume is variable between the first and second states and the second chamber volume is greater than that first chamber volume.

Preferably, the first chamber volume depends on the arrangement of the plurality of filling bodies relative to one another and relative to the shaft-shaped core and relative to the jacket. The first chamber volume can vary depending on the arrangement of the plurality of filling bodies relative to one another and relative to the shaft-shaped core and relative to the jacket. Preferably, the second chamber volume in particular does not depend on the arrangement of the plurality of filling bodies relative to one another and relative to the shaft-shaped core and relative to the jacket.

The jacket thickness can vary depending on the chamber volume. In particular, the jacket thickness of the jacket in the first state is thicker than the jacket thickness of the jacket in the second state. In a first state, the jacket thickness of the jacket is preferably at least 0.25 mm, 0.5 mm, 1 mm, 2 mm, 3 mm, 4 mm, or 5 mm and/or at most 1 mm, 2 mm, 3 mm, 4 mm, or 5 mm. In a first state, the jacket thickness of the jacket is preferably at least 0.25 mm, 0.5 mm, 1 mm, 2 mm, 3 mm, 4 mm, or 5 mm and/or at most 1 mm, 2 mm, 3 mm, 4 mm, or 5 mm.

This embodiment has the advantage that the length, circumference, and/or shape of the massage device can be varied as desired in a particularly simple manner at short notice.

According to a preferred embodiment of the massage device, the plurality of filling bodies in the chamber is freely movable and/or arbitrarily arrangeable if the chamber volume is greater than the first chamber volume and/or the plurality of filling bodies in the chamber are arranged essentially fixed between the jacket and the core when the chamber volume is equal to the first chamber volume.

This embodiment has the advantage that the length, circumference, and/or shape of the massage device can be varied as desired in a particularly simple manner at short notice.

According to a preferred refinement of the massage device, the jacket is connected to the shaft-shaped core, so that the plurality of filling bodies are arranged captively in the chamber.

The jacket and the shaft-shaped core are preferably connected to one another at least in sections in a friction-locked and/or formfitting manner. In particular, the jacket on an inside and/or the shaft-shaped core on an outside comprises a connecting projection and/or a connecting recess. In particular, the shaft-shaped core and/or jacket comprises a peripheral annular fastening groove.

Furthermore, the shaft-shaped core and/or jacket preferably comprises a peripheral annular fastening projection. Furthermore, it can be preferred that the shaft-shaped core and/or jacket are adhesively bonded.

Preferably, the jacket and the shaft-shaped core are tightly connected to each other. A jacket tightly connected to the shaft-shaped core prevents a fluid medium, for example a liquid or a gaseous medium, for example air, from penetrating into the chamber between the shaft-shaped core and the jacket.

This embodiment has the advantage that the shape of the massage device set by the user is retained even if the chamber is not sealed airtight from the environment.

In a further preferred embodiment of the massage device, the jacket is an expandable jacket.

According to a further preferred refinement of the massage device, the chamber volume is variable from the first chamber volume to the second chamber volume in a pumping operation, wherein a fluid medium is transferred into the chamber, and/or the chamber volume is variable from the second chamber volume to the first chamber volume in an emptying mode, wherein the fluid medium is transferred out of the chamber.

In particular, the chamber is filled with a fluid medium in pumping operation in such a way that there is an overpressure in the chamber in comparison to the surroundings of the massage device in order to set the desired shape and length of the massage device. If the chamber is emptied in emptying operation, the chamber in particular has a pressure which corresponds to a pressure of the surroundings. It is preferably provided that the chamber is not emptied in emptying operation in such a way that a negative pressure arises in the chamber which is lower in comparison to the pressure of the surroundings.

The fluid medium is preferably air.

This embodiment has the advantage that the length, circumference, and/or shape of the massage device can be varied as desired in a particularly user-friendly manner at short notice.

According to a further preferred refinement of the massage device, the chamber volume increases in pumping operation due to expansion of the jacket depending on the amount of fluid medium transferred into the chamber and/or in emptying operation the fluid medium is transferred out of the chamber by the contracting jacket. In particular, in pumping operation, the chamber volume increases due to the expansion of the jacket depending on the quantity of the mass of the fluid medium transferred into the chamber. Preferably, in pumping operation, the chamber volume increases due to the expansion of the jacket depending on the quantity of the volume of the fluid medium transferred into the chamber.

This embodiment has in particular the advantage that no pump is required to empty the chamber. This advantageously reduces the complexity of the massage device and in this respect both its production costs and its operating costs.

Air is preferably transferred from the surroundings into the chamber in pumping operation and/or air is transferred from the chamber into the surroundings in emptying operation. An embodiment that uses air as the fluid medium is particularly inexpensive. In such an embodiment, in particular, no reservoir for a fluid medium with corresponding connections to the chamber has to be provided and maintained.

According to a further preferred embodiment, the core and/or the plurality of filling bodies, depending on their arrangement relative to one another and relative to the core and relative to the jacket, define an inner volume and the jacket in an non-expanded state defines a jacket volume which is smaller than the inner volume.

In the non-expanded state of the jacket, the shaft-shaped core and/or the plurality of filling bodies is/are in particular not arranged inside the jacket. The jacket can also be in a non-expanded state if exclusively a shaft-shaped core is arranged inside the jacket, at least in sections. The jacket can in particular be in an expanded state when both a shaft-shaped core, at least in sections, and the plurality of filling bodies are arranged inside the jacket.

This embodiment has in particular the advantage that no pump is required to empty the chamber. Furthermore, this embodiment has the advantage that the shape and/or length and/or contour of the massage device or the jacket set in the first state is not lost over time, in particular not during use. According to a further preferred embodiment, the jacket and/or the shaft-shaped core comprises silicone and/or the plurality of filling bodies comprise a polymer.

This preferred embodiment of the massage device has the advantage that it is particularly biocompatible. Furthermore, a massage device designed in this way can be easily cleaned. In particular, a massage device comprising silicone clings to the body regions to be used in a particularly advantageous manner. Furthermore, an advantage of this embodiment of the massage device is that the plurality of filling bodies enables a particularly suitable massage application.

According to a further preferred refinement, the massage device comprises a vibration means, in particular a vibration motor, wherein the vibration means is preferably arranged inside the core; and/or a pump for conveying the fluid medium into the chamber in pumping operation; and/or a channel for transferring the fluid medium, wherein the channel connects the pump to the chamber, wherein the channel is in particular multi-part.

A multi-part channel includes, in particular, at least one or more line elements, each of which forms a part or section of the duct. In particular, the shaft-shaped core can form parts or sections of the multi-part channel, wherein the cable sections or line elements connect the cavity of the core to the chamber formed between the core and the jacket.

According to a further preferred embodiment, the massage device comprises a switchable valve, which is arranged between the pump and the chamber, in particular is arranged within the channel, and is switchable back and forth between a fluid supply position in pumping operation and an emptying position in emptying operation, wherein in the fluid supply position, the fluid medium conveyed by the pump is transferred into the chamber and in the emptying position, the fluid medium is transferred out of the chamber.

It can be preferred that a first line element couples the pump to the switchable valve. Furthermore, it can be preferred that a second line element couples the switchable valve to the cavity of the core designed as a hollow body.

According to a further preferred refinement, the massage device comprises a control unit for controlling the massage device, wherein the control unit is designed to switch the massage device back and forth between an idle mode and an operating mode, wherein the vibration means and/or the pump are switched off or is/are switched to standby in the idle mode and in the operating mode the control unit is designed to switch back and forth between pumping operation, in which the pump is switched on and the fluid medium is conveyed into the chamber, and/or emptying operation, in which the pump is switched off and the fluid medium is transferred out of the chamber, and/or vibration operation in which the vibration means is switched on and the core is excited to vibrate.

In a further preferred embodiment, the massage device comprises an energy source, wherein the energy source is in particular a battery that provides electrical energy for the vibration means and/or the pump and/or the switchable valve and/or the control unit. The battery is a lithium-ion battery, for example. It can furthermore be preferred that the energy source is a rechargeable battery or an accumulator.

This preferred embodiment has the advantage that the massage device can be used without a cable. According to a further preferred refinement, the massage device comprises a housing, in particular having a handle section, for holding the massage device, wherein the shaft-shaped core and/or the jacket are preferably connected to the housing, in particular the handle section.

In particular, the vibration means, the pump, the switchable valve, the control unit, and/or the energy source are arranged inside the housing. The massage device, in particular the handle section, preferably has a switch for switching on pumping operation, a switch for switching on emptying operation, and a switch for switching on vibration operation. Preferably at least one switch, preferably all switches, are connected to the control unit.

In this way, the massage device can be operated in a particularly advantageous manner during use. According to a further preferred embodiment, the housing of the massage device includes an air passage opening through which a fluid medium in the form of air can flow from the surroundings of the massage device in the direction of the chamber and/or out of the chamber in the direction of the surroundings.

In particular, in pumping operation, the fluid medium in the form of air can be aspirated from the surroundings of the massage device through the air passage opening by the pump and conveyed into the chamber. Furthermore, it is preferred that in emptying operation, the fluid medium in the form of air is conveyed out of the chamber through the air passage opening to the surroundings. In particular, the air passage opening is a part or section of the channel.

This preferred embodiment enables the massage device to be operated in a particularly simple and cost-effective manner. In particular, the air from the surroundings of the massage device, i.e., normal ambient air or room air, can be used in a particularly advantageous manner in pumping operation and the air can be conveyed into the chamber without additional storage or the like and in emptying operation the air can be conveyed from the chamber to the surroundings without special filtering and/or purifying devices. In particular, this embodiment insofar also enables a particularly compact and handy design of the massage device.

According to a further aspect of the invention, the object of the present invention is furthermore achieved according to a method for producing a massage device with a variable shape for physical stimulation according to claim 16.

The method for producing a massage device with a variable shape for physical stimulation, in particular a massage device with a variable shape according to the first aspect of the invention or one of the above-described preferred embodiments, comprises the following steps:
providing a jacket and a shaft-shaped core; and/or
arranging the shaft-shaped core, at least in sections, inside the jacket; and/or
filling the jacket with a plurality of filling bodies; and/or
fastening the jacket to the shaft-shaped core, so that the jacket encloses the shaft-shaped core at least in sections and the plurality of filling bodies are arranged captively in a chamber between the shaft-shaped core and the jacket.

According to a further aspect, the object mentioned at the outset is achieved by a method for deforming a massage device with a variable shape for physical stimulation according to claim 16.

The method for deforming a massage device with a variable shape for physical stimulation, in particular a massage device with a variable shape according to the first aspect of the invention or one of the above-described preferred embodiments, comprises the following steps:
switching on the massage device from an idle mode to a pumping operation of an operating mode in which the pump is switched on, and
conveying the fluid medium into a chamber between a jacket and a shaft-shaped core in pumping operation, and
arranging and retaining the plurality of filling bodies in a desired position, location, and/or shape in the chamber, and
switching the operating mode from pumping operation to emptying operation, and
emptying the chamber in emptying operation by transferring the fluid medium out of the chamber, and/or
switching to a vibration operation of the operating mode in which the vibration means is switched on, and
vibrating the shaft-shaped core excited by the vibration means, and/or
switching off the massage device from the operating mode to the idle mode.

With regard to the advantages, embodiments, and design details of these two further aspects and their possible refinements, reference is also made to the preceding description of the corresponding features of the massage device.

Preferred embodiments of the invention are described by way of example with reference to the accompanying figures. In the figures:

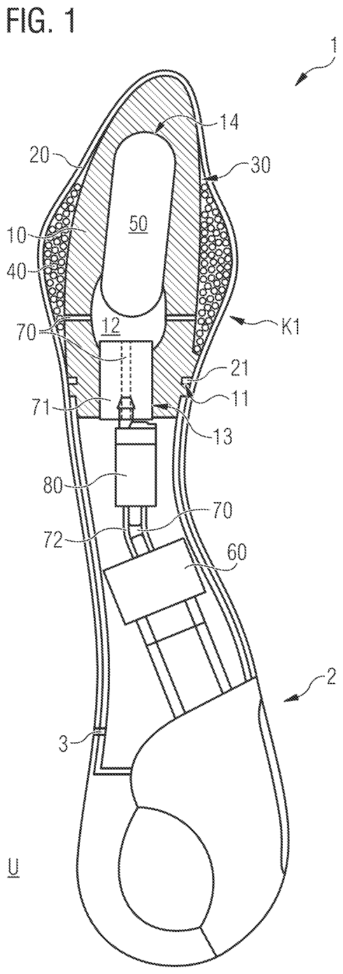

FIG. 1 shows a schematic sectional view of a preferred embodiment of a massage device;

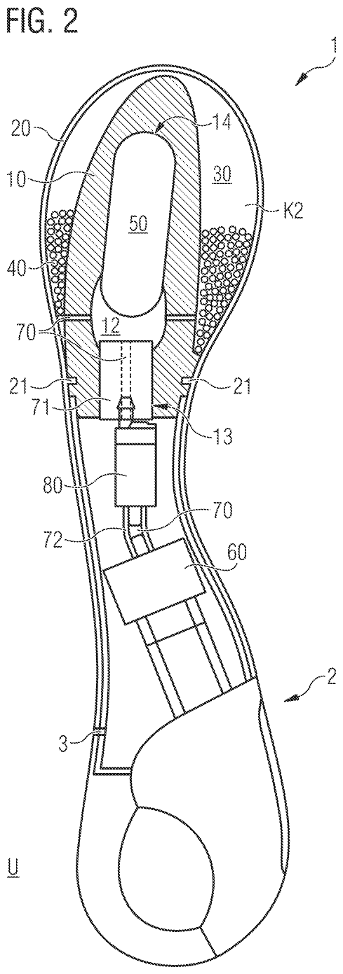

FIG. 2 shows the massage device from FIG. 1, shown in a further schematic sectional view, in a second operating state;

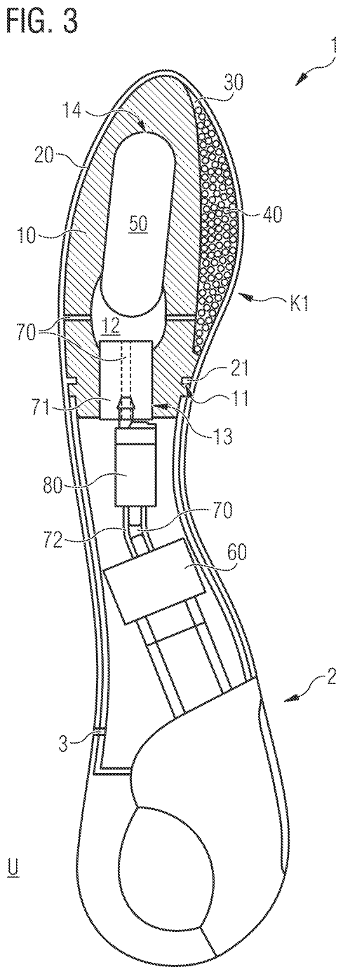

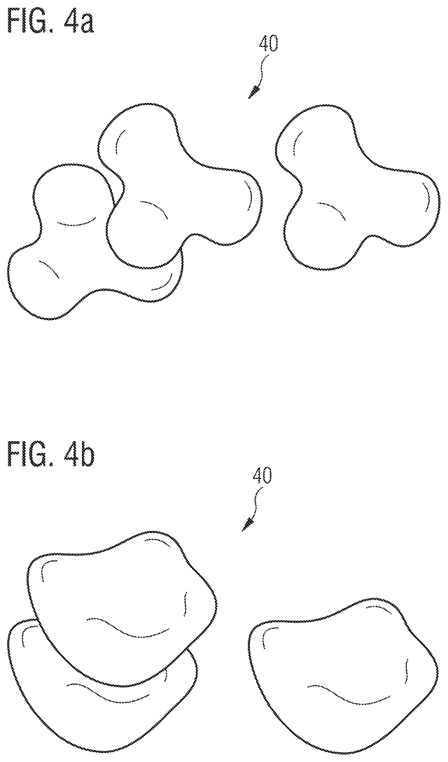

FIG. 3 shows the massage device from FIG. 1, shown in a further schematic sectional view, in a third operating state;

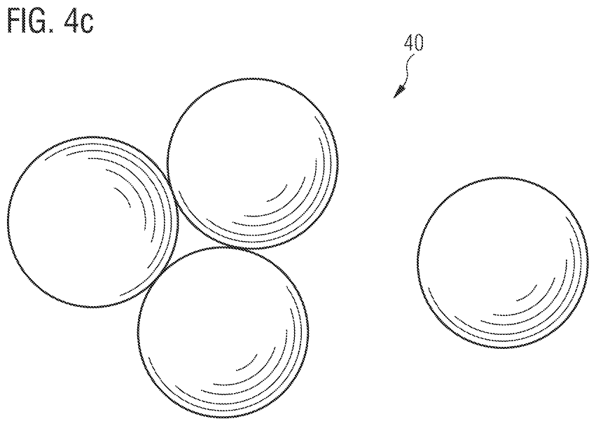

FIGS. 4a to 4c show a schematic representation of preferred embodiments of a plurality of filling bodies;

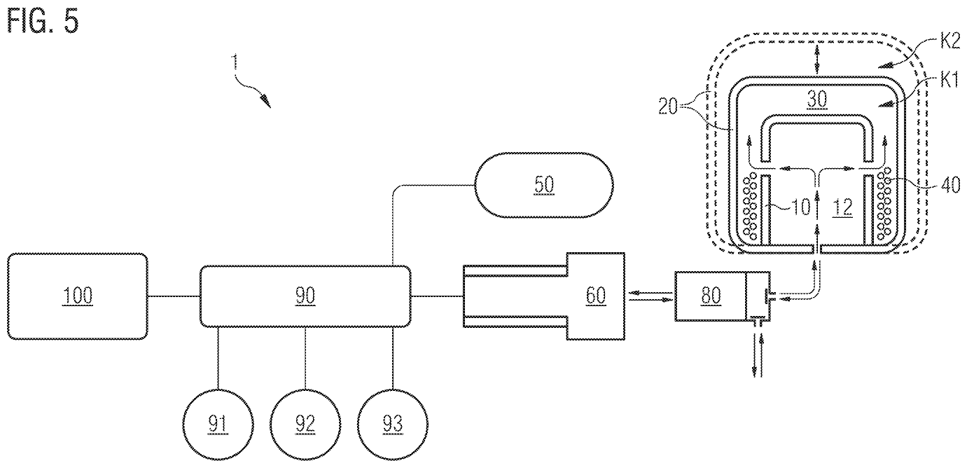

FIG. 5 shows a schematic block diagram of a preferred embodiment of a massage device;

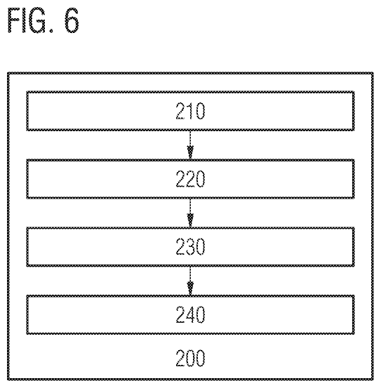

FIG. 6 shows a schematic flow chart showing exemplary steps of a method for producing a massage device; and

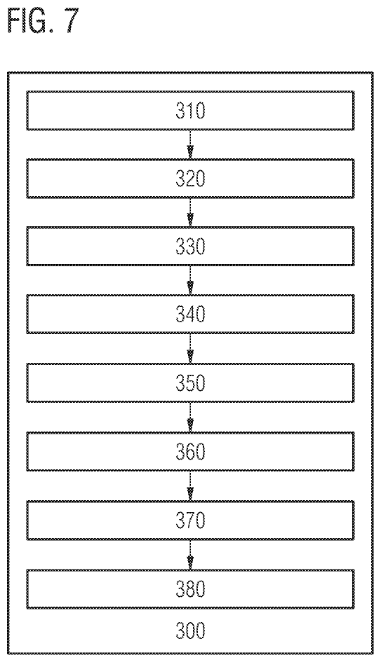

FIG. 7 shows a schematic flow chart showing exemplary steps of a method for deforming a massage device.

The massage device 1 shown schematically in a preferred embodiment in FIGS. 1 to 3 comprises a shaft-shaped core 10 and a jacket 20, within which the shaft-shaped core 10 is completely arranged. A chamber 30 is formed between the shaft-shaped core 10 and the jacket 20. A plurality of filling bodies 40 is arranged inside the chamber. Both the shaft-shaped core 10 and the jacket 20 preferably comprise silicone.

The shaft-shaped core 10 is connected to the jacket 20. For this purpose, the shaft-shaped core 10 has a peripheral groove on an outside. The circumferential groove is designed in particular as an annular peripheral groove. As a counterpart, the jacket 20 has a peripheral connecting projection 21 on an inside. The peripheral connecting projection 21 is designed in particular as an annular peripheral connecting projection. This connecting projection formed by the jacket 20 engages in the groove 11 formed on the shaft-shaped core 10 in a friction-locked and formfitting manner. It can be preferred that the jacket 20 and the shaft-shaped core 10 are additionally or alternatively adhesively bonded to one another. In particular, the jacket 20 and the shaft-shaped core 10 can be adhesively bonded to one another in the area of the groove 11 and recess 21. This type of connection has the advantage that the plurality of filling bodies 40 are arranged captively in the chamber 30 between the jacket 20 and the shaft-shaped core 10.

The shaft-shaped core 10 is designed as a hollow body. As a hollow body, the shaft-shaped core defines a cavity 12 which, starting from an opening, extends in a longitudinal direction into an interior of the shaft-shaped core 10 up to a head end 14 of the shaft-shaped core 10. Inside the shaft-shaped core 10, a vibration motor 50 is arranged. This has the advantage that the shaft-shaped core 10 can be excited to vibrate. The vibration motor 50 is inserted into the cavity of the shaft-shaped core 10 up to the head end 14. In the preferred embodiment shown in the present case, the vibration motor 50 is mechanically, in particular in a friction-locked and/or adhesively bonded manner, coupled to an inside of the shaft-shaped core 10. However, it can also be preferred that the vibration motor 50 is additionally or alternatively mechanically coupled to the inside of the shaft-shaped core 10 in a formfitting manner. In particular, the motor 50 excites the shaft-shaped core to vibrate in a vibration operation.

A channel 70, which is multi-part in the present preferred embodiment, connects the chamber 30 to the pump 60. Starting from the cavity 12 of the shaft-shaped core 10, sections of the multi-part channel 70 extend in a radial direction, essentially orthogonal to the longitudinal direction. These sections of the channel 70 connect the chamber 30 to the cavity 12 of the shaft-shaped core 10. Starting from the opening 13 of the shaft-shaped core 10 designed as a hollow body, a first line element 71 of the multi-part channel 70 is furthermore arranged. A valve 80 is connected to the first line element 71 of the channel. The valve 80 is in turn connected to a pump 60 via a further, second line element 72 of the multi-part channel 70. The first and second line element 71, 72 are line sections which are designed in particular as a first and second line hose 71, 72. The channel 70 is designed to transfer a fluid medium starting from the pump 60 to the chamber 30. The pump 60 is designed to convey a fluid medium into the chamber 30 in a pumping operation. For this purpose, the switchable valve 80 is switched to a fluid supply position in pumping operation, so that the fluid medium conveyed by the pump 60 is transferred into the chamber 30. The switchable valve 80 can be switched to an emptying position, so that the fluid medium can escape from the chamber via the valve 80.

In this preferred embodiment of the massage device 1, the vibration motor 50, the valve 80, and the pump 60 are connected to an energy source (100, not shown in FIGS. 1 to 3).

FIGS. 1 and 3 show the preferred embodiment of the schematically shown massage device 1 in a first state having a first chamber volume K1. The first chamber volume K1 shown in FIG. 1 differs from the first chamber volume K1 shown in FIG. 3. This is because the first chamber volume K1 depends on the arrangement of the plurality of filling bodies relative to one another and relative to the shaft-shaped core and relative to the jacket. FIG. 2 shows the preferred embodiment of the schematically shown massage device 1 in a second state having a second chamber volume K2. The second chamber volume K2 is greater than the first chamber volume K1 shown in FIG. 1 or 3. In this second state, the user can advantageously position the filling bodies in any desired position, shape, and location. Starting, for example, from the annular arrangement of the plurality of filling bodies shown in FIG. 1, he can position the filling bodies exclusively on one side in the second state, as shown in FIG. 3.

FIGS. 4a to 4c schematically show preferred embodiments of filling bodies 40 of the plurality of filling bodies 40 which can be arranged in a chamber 30. FIG. 4a shows a three-legged filling body. FIG. 4b shows a chip-shaped filling body 40. FIG. 4c shows a spherical filling body 40. The filling bodies 40 of the plurality of filling bodies 40 preferably include a polymer. In FIGS. 1 to 3, the filling bodies 40 are designed identically as bead-shaped filling bodies 40.

FIG. 5 schematically shows a massage device 1. In this preferred embodiment, the massage device 1 comprises a shaft-shaped core 10 designed as a hollow body, which is arranged inside a jacket 20. A plurality of filling bodies 40 is arranged between the shaft-shaped core 10 and the jacket 20. The shaft-shaped core 10 and the jacket 20 are connected to one another, so that the filling bodies 40 arranged in the chamber are also arranged captively. In particular, the shaft-shaped core 10 and the jacket 20 are tightly connected to one another, so that no fluid medium escapes from the chamber between the shaft-shaped core 10 and the jacket 20 during pumping operation.

The shaft-shaped core 10 is connected to a pump 60 via a channel 70 (not shown). A switchable valve 80 is arranged in the channel 70. The pump 60 and the switchable valve 80 are connected to a control unit 90 to transmit signals. Furthermore, a motor 50 is connected to the control unit 90 to transmit signals. In this preferred embodiment, a 3.7 V lithium-ion battery is used as the energy source. However, other energy sources 100 are also conceivable. The battery 100 supplies the motor 50, the pump 60, and the switchable valve 80 with energy. Furthermore, the energy source 100 supplies the control unit 90 with energy. The motor 50, the pump 60, and the switchable valve 80 are connected to transmit energy to the energy source 50 via the control unit.

The control unit 90 is designed to control the massage device 1. In particular, the control unit 90 is designed to control the vibration means 50, the pump 60, and the switchable valve 80. The massage device 1 can be switched back and forth between an idle mode and an operating mode using the control unit 90. In the idle mode, the vibrating means 50 and/or the pump 60 are switched off or switched to stand-by. For this purpose, the massage device 1 can include a corresponding switch (not shown). In the operating mode, the control unit 90 is designed to switch back and forth between pumping operation, emptying operation, and vibration operation. In pumping operation, the pump 50 is switched on and a fluid medium is transferred into the chamber 30. In emptying operation, in which the pump 50 is switched off, the fluid medium is transferred out of the chamber 30. In vibration operation, in which the vibration means 50 is switched on, the core 10 is excited to vibrate. For this purpose, the massage device 1, in particular the handle section, includes a switch 91 for switching on pumping operation, a switch 92 for switching on emptying operation, and a switch 93 for switching on vibration operation, wherein the switches 91, 92, 93 are arranged on the handle section and are connected to the control unit 90 to transmit signals.

Furthermore, the switchable valve 80 is switchable back and forth between a fluid supply position in pumping operation and an emptying position in emptying operation. In the fluid supply position, the fluid medium conveyed by the pump 50 is transferred into the chamber 30. In the emptying position, the fluid medium is transferred out of the chamber 30.

Advantageously, the fluid medium is effectuated in the emptying position by a contracting jacket 20. This results because in pumping operation the chamber volume increases due to expansion of the jacket 20 depending on the fluid medium transferred into the chamber 30 and in emptying operation the fluid medium is transferred out of the chamber 30 by the contracting jacket 20. This effect is preferably strengthened when the jacket 20, in a non-expanded state, defines a jacket volume that is less than an internal volume which the core 10 and/or the plurality of filling bodies 40 define, depending on their arrangement relative to one another and relative to the core 10 and relative to the jacket 20.

In the preferred embodiments of a massage device shown in FIGS. 1 to 3 and 5, it is preferably provided that air is transferred from the surroundings U into the chamber in pumping operation and air is transferred from the chamber via the valve to the surroundings U in emptying operation. For this purpose, a massage device can include an air passage opening 3 in a housing, in particular a handle section, as shown in FIGS. 1 to 3. This allows air from the surroundings U of the massage device, i.e., normal ambient air or room air, to be used in pumping operation and the air to be conveyed into the chamber 30 without an additional reservoir or the like. Furthermore, the air passage opening 3 enables the air to be conveyed out of the chamber 30 into the surroundings U without special filtering and/or purifying devices in emptying operation.

FIG. 6 is a schematic flow chart showing exemplary steps of a preferred embodiment of a method 200 for producing a massage device.

The method 200 for producing a massage device comprises providing 210 a jacket 20 and a shaft-shaped core 10. In this preferred embodiment, it is then provided that the shaft-shaped core 10 is arranged 220, at least in sections, inside the jacket 20. This is followed by filling 230 of the jacket 20 with a plurality of filling bodies 40. Alternatively, it can first be provided that the jacket 20 is filled 230 with a plurality of filling bodies 40 and then the shaft-shaped core 10 is arranged 220, at least in sections, inside the jacket 20. Fastening 240 the jacket 20 on the shaft-shaped core 10 is then preferred, so that the jacket 20 encloses the shaft-shaped core 10 at least in sections and the plurality of filling bodies 40 are arranged captively in a chamber 30 between the shaft-shaped core 10 and the jacket 20.

FIG. 7 is a schematic flow chart showing exemplary steps of a preferred embodiment of a method 300 for deforming a massage device.

The method 300 for deforming a massage device comprises switching on 310 the massage device 1 from an idle mode into pumping operation of an operating mode in which the pump 60 is switched on. In this preferred embodiment, after the step of switching on 310, the fluid medium is conveyed 320 into a chamber 30 between a jacket 20 and a shaft-shaped core 10 in pumping operation.

Subsequently, arranging 330 and retaining the plurality of filling bodies 40 in a desired position, location, and/or shape in the chamber 30 is preferred. Switching 340 of the operating mode from pumping operation to emptying operation can then follow. In emptying operation, the chamber 30 is emptied 350 by transferring the fluid medium out of the chamber 30. Switching 360 to a vibration operation of the operating mode is then provided, in which the vibration means 50 is switched on and vibration 370 of the shaft-shaped core 10 is excited by the vibration means 50. The method 300 for deforming a massage device can be completed by switching off 380 the massage device 1 from the operating mode to the idle mode.

### LIST OF REFERENCE SIGNS

1 massage device
2 housing
3 air passage opening
10 core
11 peripheral groove
12 cavity of the shaft-shaped core
13 opening of the hollow body
14 head end
20 jacket
21 peripheral recess
30 chamber
40 filling bodies
50 vibration means
60 pump
70 channel
71 first line element
72 second line element
80 valve
90 control unit
91 switch for switching on pumping operation
92 switch for switching on emptying operation
93 switch for switching on vibration operation
100 energy source
K1 first chamber volume
K2 second chamber volume
U surroundings

1. A massage device with a variable shape for physical stimulation, comprising:
a shaft-shaped core;
a jacket within which the shaft-shaped core is arranged at least in sections; and
a chamber formed between the shaft-shaped core and the jacket,
wherein
the chamber contains a plurality of filling bodies which give the jacket a variable shape depending on their arrangement relative to one another and relative to the shaft-shaped core and relative to the jacket.

2. The massage device according to claim 1, wherein
the chamber has a chamber volume which has a first chamber volume in a first state and a second chamber volume in a second state, wherein the chamber volume is variable between the first and second states and the second chamber volume is greater than the first chamber volume.

3. The massage device according to claim 1, wherein
the plurality of filling bodies in the chamber is at least one of freely movable, arrangeable if the chamber volume is greater than the first chamber volume, or
arranged substantially fixed between the jacket and the core if the chamber volume is equal to the first chamber volume.

4. The massage device according to claim 1, wherein the jacket is connected to the shaft-shaped core so that the plurality of filling bodies is arranged captively in the chamber.

5. The massage device according to claim 1, wherein the jacket is an expandable jacket.

6. The massage device according to claim 1, wherein:
in a pumping operation, the chamber volume is variable from the first chamber volume to the second chamber volume, wherein a fluid medium is transferred into the chamber, and/or
in an emptying operation, the chamber volume is variable from the second chamber volume to the first chamber volume, wherein the fluid medium is transferred out of the chamber.

7. The massage device according to claim 6, wherein:
in pumping operation, the chamber volume increases due to expansion of the jacket depending on the amount of fluid medium transferred into the chamber, and/or
in emptying operation, the fluid medium is transferred out of the chamber by the contracting jacket.

8. The massage device according to claim 1, wherein:
the core and/or the plurality of filling bodies define an inner volume depending on their arrangement relative to one another and relative to the core and relative to the jacket, and
the jacket, in a non-expanded state, defines a jacket volume that is smaller than the inner volume.

9. The massage device according to claim 1, wherein:
the jacket comprises silicone; and/or
the shaft-shaped core comprises silicone; and/or
the plurality of filling bodies comprises polymer.

10. The massage device according to any claim 1, further comprising:
a vibration means, in particular a vibration motor, wherein the vibration means is arranged inside the core; and/or
a pump for conveying the fluid medium into the chamber in pumping operation; and/or
a channel for transferring the fluid medium, wherein the channel connects the pump to the chamber, wherein the channel is in particular multi-part.

11. The massage device according to claim 10, further comprising:
a switchable valve arranged between the pump and the chamber, in particular arranged within the channel, and switchable back and forth between a fluid supply position in pumping operation and an emptying position in emptying operation, wherein
in the fluid supply position, the fluid medium conveyed by the pump is transferred into the chamber, and
in the emptying position, the fluid medium is transferred out of the chamber.

12. The massage device according to claim 10, further comprising:
a control unit for controlling the massage device, wherein the control unit is designed to switch the massage device back and forth between an idle mode and an operating mode, wherein
in the idle mode, the vibration means and/or the pump is/are switched off or switched to stand-by, and
in the operating mode, the control unit is designed to switch back and forth between at least one of:
pumping operation, in which the pump is switched on and the fluid medium is conveyed into the chamber, or
emptying operation, in which the pump is switched off and the fluid medium is transferred out of the chamber, or
vibration operation, in which the vibration means is switched on and the core is excited to vibrate.

13. The massage device according to claim 10, further comprising:
an energy source, wherein the energy source is in particular a battery which provides electrical energy for the vibration means and/or the pump and/or the switchable valve and/or the control unit.

14. The massage device according to claim 1, further comprising:
a housing having a handle section for holding the massage device, wherein at least one of the shaft-shaped core or the jacket are connected to at least one of the housing or the handle section.

15. The massage device according to claim 14, wherein the housing includes an air passage opening through which a fluid medium in the form of air can flow from the surroundings of the massage device in the direction of the chamber and/or out of the chamber in the direction of the surroundings.

16. A method for producing a massage device with a variable shape for physical stimulation, the massage device comprising—a shaft-shaped core, a jacket within which the shaft-shaped core is arranged at least in sections, and a chamber formed between the shaft-shaped core and the jacket, wherein the chamber contains a plurality of filling bodies which give the jacket a variable shape depending on their arrangement relative to one another and relative to the shaft-shaped core and relative to the jacket, the method comprising at least one of:
providing a jacket and a shaft-shaped core;
arranging the shaft-shaped core, at least in sections, inside the jacket;
filling the jacket with a plurality of filling bodies; or
fastening the jacket to the shaft-shaped core, so that the jacket encloses the shaft-shaped core at least in sections and the plurality of filling bodies is arranged captively in a chamber between the shaft-shaped core and the jacket.

17. A method for deforming a massage device with a variable shape for physical stimulation, the massage device comprising a shaft-shaped core, a jacket within which the shaft-shaped core is arranged at least in sections, and a chamber formed between the shaft-shaped core and the jacket, wherein the chamber contains a plurality of filling bodies which give the jacket a variable shape depending on their arrangement relative to one another and relative to the shaft-shaped core and relative to the jacket, the method comprising:
switching on the massage device from an idle mode into pumping operation of an operating mode in which the pump is switched on;
conveying the fluid medium into a chamber between a jacket and a shaft-shaped core in pumping operation;
arranging and retaining the plurality of filling bodies in a desired position, location, and/or shape in the chamber;
switching the operating mode from pumping operation to emptying operation;
at least one of emptying the chamber in emptying operation by transferring the fluid medium out of the chamber or switching to a vibration operation of the operating mode in which the vibration means is switched on; and
at least one of vibrating the shaft-shaped core excited by the vibration means or
switching off the massage device from the operating mode to the idle mode.
